(19) United States
(12) Patent Application Publication
(10) Pub. No.: US 2009/0173909 A1
(43) Pub. Date: Jul. 9, 2009

(54) CAUSTIC PRODUCT WITH FREEZE PROTECTION

(75) Inventors: Hasan Dindi, Wilmington, DE (US); Andrew Francis Gonzon, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY

(21) Appl. No.: 12/337,799

(22) Filed: Dec. 18, 2008

Related U.S. Application Data
(60) Provisional application No. 61/010,096, filed on Jan. 4, 2008.

(51) Int. Cl. B01D 53/74; C09K 5/00

(52) U.S. Cl. 252/76; 252/71; 423/210

(57) ABSTRACT

A freeze-protected concentrated solution of alkali metal hydroxide comprising (a) at least 46% by weight of alkali metal hydroxide wherein at least 80% by weight of the alkali metal hydroxide is sodium hydroxide and (b) no more than 1.5% by weight of an additive selected from the group consisting of sulfuric acid and its alkali metal salts, citric acid and its alkali metal salts, and triglyceride. The freeze-protected solution has a freeze point of 5° C. or less, and thus is able to withstand temperatures below the normal freeze points of concentrated alkali metal hydroxide solutions. A process to prepare of the freeze-protected solution comprises adding the additive to a concentrated alkali metal hydroxide solution.

### FIELD OF THE INVENTION

The present invention relates to a process for making a freeze protected 50% caustic solution suitable for use in cold weather applications.

### BACKGROUND OF THE INVENTION

Many uses exist for caustic soda solution (aqueous sodium hydroxide) in industrial applications. Such uses include aqueous pH control, acid neutralization, as a phase transfer material, scrubbing material for acid gases such as SO₂, and as a cleaner. Often, caustic solution is in the form of a concentrated caustic solution, that is, nominally 50% sodium hydroxide by weight, which may vary between 46% and 55% sodium hydroxide. Bulk concentrated caustic solution is stored in storage tanks prior to use. The concentrated caustic solution is transferred to process vessels from storage tanks and may be subsequently diluted to a specified concentration depending on the desired use/application.

Concentrated caustic solution has a freeze point of about 11-12° C. (52-54° F.). For shipping, the solution is frequently transferred into tank trucks or tank cars at a temperature above 32° C. (90° F.) and transported to a destination. If the temperature at the destination is cold, that is, below the freeze point of the caustic, the truck or car may need to be heated prior to unloading. This is a time-consuming and expensive operation. Typically a steam-heated pad is used over several days to heat the frozen contents of the truck or car for transfer to a storage tank. The transfer lines from the truck or car to the storage tank may also need to be heat-traced to avoid solids forming in the lines thus to prevent plugging. A heater may also be needed to keep the solution above its freezing point in the storage tank. Insulation for tanks and lines is expensive to install and to maintain, especially when the tanks or lines need maintenance or servicing or when the insulation needs to be removed and replaced, thus increasing operating costs.

One option to avoid freezing caustic is to use lower concentrations of caustic solution. This option results in transporting and/or storing large quantities of water, which is undesirable due to added cost of transporting and storing water. Higher caustic concentrations are desired to reduce the size of the storage tank and reduce the number of and cost of deliveries. In addition, concentrated caustic may be desired for a particular application, thus, lower concentrations are not suitable, or additional costs are incurred to remove water from lower concentration caustic solutions.

A second option to avoid freezing of concentrated caustic solution is to add an acid and/or salt and/or other additive to the caustic solution to lower the freeze point, i.e., freezing-point depression effect of salt. Heretofore, acids and salts and other additives, while effective at reducing freeze point of caustic, are used in amounts that reduce the concentration of NaOH to less than that of a concentrated solution, that is, nominally between 46% and 55% sodium hydroxide, by weight.

Seward, in J. Am. Chem. Soc., 77, (1955) 5507-8, discloses lowering the freeze point of sodium hydroxide by adding salts, such as NaBr, KBr, K₂CO₃ and Na₂CO₃, in amounts ranging from 1.68% to 13.13% by weight, to sodium hydroxide solution for freezing-point depression. The freeze point of the solution is lowered to between −7 to 9° C. (19 and 48° F.) using this method. While additives are successful in lowering the freeze point, high levels of salt are needed, reducing the NaOH concentration.

Stoll, in U.S. Pat. No. 4,064,065, discloses a composition of a mixed caustic solution prepared by mixing 50% NaOH solution with 45% KOH solution at a weight ratio of 2:1 NaOH solution to KOH solution. The mixed caustic solution has a freeze point of −17.8° C. (0° F.). While this ratio of components lowers the freeze point of the resulting caustic, it weakens the strength of the caustic solution since KOH is a weaker base than NaOH, thus rendering the caustic solution less effective or requiring more solution (larger vessel) compared with concentrated sodium hydroxide solution. In addition, potassium hydroxide is more expensive, increasing the cost of the solution.

Ames discloses additives for lowering the freeze point of caustic solutions in a number of U.S. Pat. Nos. 4,971,713; 5,037,571; and 5,100,570. These solutions are useful as phase change materials (“PCM”), for thermal energy storage. Ames discloses lowering the freeze point of 46 to 54% sodium hydroxide solution to 5° C. (41° F.). In U.S. Pat. No. 4,971,713, 3-5 parts of a nucleating agent (CaCO₃, Fe₃O₄, FeO, TiO₂, SnO₂, TeO₂ or LiAl(SiO₄)) are added per 47 parts of NaOH and 53 parts of water. In U.S. Pat. No. 5,037,571, 3% by weight sodium dichromate or sodium chromate is added to lower the freeze point of 46 to 54% sodium hydroxide solution to 5° C. (41° F.). In U.S. Pat. No. 5,100,570, one or more inorganic salts is added to 39% sodium hydroxide solution to reduce the freeze point to 8° C. (47° F.).

Talley, in U.S. Pat. No. 5,942,481, discloses a caustic cleaning solution comprising at least 35% by weight NaOH and at least about 1% by weight, preferably 1.5 to 9% by weight of an organic salt derived from the reaction of gluconic acid and NaOH. The cleaning solution is prepared by adding gluconic acid to NaOH solution. The resulting cleaning caustic solution had a freeze point of 4.4° C. (40° F.). Optionally, an inorganic salt such as sodium silicate or potassium silicate or potassium hydroxide (preferred) provides additional reduction in freeze point. Solutions prepared according to Talley's Examples contained no more than 39% NaOH by weight.

Thus, there remains a need for a freeze-protected caustic product and process to prepare such product for use in locations where temperatures are below the freeze point of concentrated (46-55%) sodium hydroxide solutions. It is desirable to minimize use of other chemicals (no more than 1% by weight, based on total weight of the solution) to minimize cost of the freeze-protected product and to maintain the strength of the caustic or to minimize undesirable by-products. The present invention meets these needs.

### SUMMARY OF THE INVENTION

The present invention provides a freeze-protected caustic solution comprising at least 46%, preferably 50 to about 55% by weight, based on total weight of the solution, of an alkali metal hydroxide, and no more than 1.5%, preferably 100 to 10,000 parts per million by weight (ppmw) (0.01 to 1% by weight, based on total weight of the solution) of an additive, wherein the additive is selected from the group consisting of sulfuric acid and its alkali metal salts, citric acid and its alkali metal salts, and triglyceride. The solution has a freeze point of 5° C. (41° F.) or less, preferably −4° C. to 5° C. (24 to 41° F.). The alkali metal can be sodium, potassium or a combination of thereof, wherein at least 80% of the total weight of alkali metal hydroxide is sodium hydroxide. Preferably 95 to 100% of the total weight of alkali metal hydroxide is sodium hydroxide, more preferably 99 to 100% is sodium hydroxide.

Surprisingly, a highly concentrated alkali metal hydroxide solution, nominally 50% by weight, is provided with a reduced freeze point, that has substantially the same alkalinity of the untreated solution. Very low concentrations (1.5% or less) of additive is necessary to achieve the desired freeze protection. It will be appreciated by those skilled in the art that mixed (sodium and potassium) hydroxide solutions will have an initial freeze point less than the freeze point of 100% sodium hydroxide (11-12° C., 52-54° F.). The addition of the additives disclosed herein will still further reduce the freeze of the combined mixed hydroxide/additive solution, while maintaining substantially the same alkalinity as the untreated solution.

The invention further provides a process to prepare a freeze-protected alkali metal hydroxide solution wherein the process comprises adding an additive selected from the group consisting of sulfuric acid and its alkali metal salts, citric acid and its alkali metal salts, and triglyceride to an alkali metal hydroxide solution comprising at least 46% by weight of alkali metal hydroxide, preferably 50 to 55% by weight, wherein at least 80% by weight of the alkali metal hydroxide is sodium hydroxide. Thus, the sodium salt can be administered to the caustic as the salt dissolved in water or caustic solution or the alkali metal sulfate can be made in situ by adding sulfuric acid, preferably diluted in water, to the alkali metal hydroxide solution.

The freeze-protected caustic solution of this invention is particularly useful in applications for scrubbing acid gases from gas streams comprising acid gases. Thus, there is further provided a process for scrubbing acid gases from gas streams comprising acid gases, which process comprises contacting the gas stream with a freeze-protected alkali metal hydroxide solution, comprising an alkali metal hydroxide and an additive, wherein the alkali metal hydroxide concentration in the solution is at least 46% by weight, based on total weight of the solution, and at least 80% by weight of the alkali metal hydroxide is sodium hydroxide; and the additive is selected from the group consisting of sulfuric acid and its alkali metal salts, citric acid and its alkali metal salts, and triglyceride, wherein the additive concentration is no more than 1.5% by weight, based on total weight of the solution.

### DETAILED DESCRIPTION OF THE INVENTION

The present invention provides a freeze-protected caustic solution comprising (a) at least 46% by weight, based on total weight of the solution, of an alkali metal hydroxide, and (b) no more than 1.5% by weight, preferably 0.01 to 1% by weight (100 to 10,000 parts per million by weight, ppmw) of an additive, wherein at least 80% of the total weight of alkali metal hydroxide is sodium hydroxide, and wherein the additive is selected from the group consisting of sulfuric acid and its alkali metal salts, citric acid and its alkali metal salts, and triglyceride. Preferably the freeze-protected solution comprises at least 50% by weight of alkali metal hydroxide; more preferably, the freeze-protected solution comprises 50-55% by weight of alkali metal hydroxide. The freeze-protected solution may alternatively comprise 48-50% by weight of alkali metal oxide.

There is further provided a freeze-protected caustic solution comprising (a) at least 46% by weight, based on total weight of the solution, of an alkali metal hydroxide, and (b) less than 1.0% by weight, preferably 0.01 to 0.5% by weight (100 to 5000 parts per million by weight, ppmw), more preferably 100 to 1000 ppmw, of alkali metal salt of gluconic acid, wherein at least 80% of the total weight of alkali metal hydroxide is sodium hydroxide. It is surprising that such low concentrations of gluconic acid, alkali metal salt can provide freeze-protection, as much higher concentrations are used with lower concentrations of sodium hydroxide to freeze-protect cleaning solutions.

By “freeze-protected caustic solution” it is meant that a solution comprising at least 46% by weight alkali metal hydroxide and no more than 1.5% by weight of the chosen additive, wherein at least 80% by weight of the total alkali metal hydroxide is sodium hydroxide and the remaining alkali metal hydroxide is potassium hydroxide, has a freeze point of 5° C. (41° F.) or less. Preferably at least 95%, more preferably 99-100%, and most preferably 100% of the total alkali metal hydroxide is sodium hydroxide. Preferably, the freeze-protected caustic solution has a freeze point of −4° C. to 5° C. (24 to 41° F.). Preferably, the freeze-caustic solution comprises no more than 1% by weight of the additive.

The present invention further provides a process to prepare the freeze-protected caustic solution of this invention, which comprises adding an additive selected from the group consisting of sulfuric acid and its alkali metal salts, citric acid and its alkali metal salts, and triglyceride, to an alkali metal hydroxide solution comprising at least 46% by weight of alkali metal hydroxide, preferably, 50 to 55% by weight, wherein at least 80% by weight of the alkali metal hydroxide is sodium hydroxide. Alternatively the alkali metal hydroxide solution comprises 48-50% by weight of alkali metal hydroxide. Conveniently, the additive can be added directly to the alkali metal hydroxide solution, as the acid, to prepare the corresponding salt in situ. Alternatively, an alkali metal salt solution of the corresponding acid or triglyceride may be added to the alkali metal hydroxide solution.

### Alkali Metal Hydroxide Solution

Alkali metal hydroxide solutions are commonly prepared by mixing alkali metal hydroxides with water. Concentrated caustic solution (nominally 50% by weight, but at least 46% by weight, and up to 55% by weight, sodium hydroxide in water) is frequently desired due to its strong alkalinity. Potash, as referred to herein, is potassium hydroxide, another example of an alkali metal hydroxide. Concentrated potassium hydroxide or potash can be prepared as a 45% by weight solution of potassium hydroxide in water. Concentrated solutions of both caustic and potash are available commercially.

Mixed concentrated caustic solutions can be prepared by mixing concentrated solutions of sodium hydroxide with potassium hydroxide. Addition of potassium hydroxide to sodium hydroxide solution weakens the alkaline strength of the solution. Still, mixed solutions may be used where a slight decrease in alkalinity is acceptable. Mixed solutions should have at least 80% sodium hydroxide of the total weight of alkali metal hydroxide and no more than 20% potassium hydroxide, e.g., a weight ratio of at least 80:20 sodium hydroxide to potassium hydroxide. Preferably, at least 95% of the alkali metal hydroxide is sodium hydroxide and no more than 5% is potassium hydroxide, e.g., a weight ratio of at least 95:5 sodium hydroxide to potassium hydroxide. More preferably, at least 99% of the alkali metal hydroxide is sodium hydroxide and no more than 1% is potassium hydroxide, e.g., a weight ratio of at least 99:1 sodium hydroxide to potassium hydroxide. Most preferably, 100% of the total alkali metal hydroxide is sodium hydroxide. Thus, according to this invention, concentrated alkali metal hydroxide solution refers to concentrated caustic solution as well as mixed caustic/potash solutions.

It will be understood by those skilled in the art that a solution wherein the alkali metal hydroxide content is less than 100% sodium hydroxide, based on total weight of alkali metal hydroxide, will have a lower freeze point than a solution wherein 100% of alkali metal hydroxide is sodium hydroxide. Thus, if desired to have freeze points lower than −4° C., in a concentrated alkali metal hydroxide solution (having total alkali metal hydroxide concentration of at least 46% by weight), a mixed sodium/potassium hydroxide solution may be desired. It will also be appreciated by those skilled in the art that reducing the relative concentration of sodium hydroxide and increasing the concentration of potassium hydroxide will reduce alkalinity of the resulting solution. For applications in which highest alkalinity is desired or needed, or when there is desire or need to minimize potassium concentration, 100% of alkali metal hydroxide concentration should be sodium hydroxide.

### Additives

The additive is selected from the group consisting of sulfuric acid and its alkali metal salts, citric acid and its alkali metal salts, and triglyceride, wherein alkali metal is sodium or potassium or a mixture thereof, preferably sodium, and the triglyceride is a vegetable oil or an animal fat or oil.

Preferably the additive is sulfuric acid or its alkali metal salt, more preferably, the additive is sulfuric acid or sodium sulfate.

Preferred triglyceride is vegetable oil, more preferably vegetable oil selected from the group consisting of canola oil and soybean oil, most preferably, soybean oil.

The additive is always added to the concentrated alkali metal hydroxide solution, rather than adding concentrated hydroxide solution to the additive. The additive may be pre-dissolved, for example, in water or aqueous alkali metal hydroxide solution. Alkali metal sulfate salt solution can be prepared by pre-dissolving solid alkali metal sulfate in water or by pre-dissolving alkali metal sulfate or sulfuric acid in aqueous alkali metal hydroxide solution. By “pre-dissolving”, it is meant to dissolve prior to adding to the concentrated alkali metal hydroxide solution in preparing the freeze-protected solution. While other basic solutions (e.g., metal carbonate solutions) or salts solutions (e.g., metal chloride solutions) can be used, it is desirable to minimize adding other components, which reduce concentration of alkali metal hydroxide, particularly concentration of sodium hydroxide. Components that may interfere with use of the solutions of this invention should be avoided.

It may be convenient to pre-dissolve the additive as the amount of additive relative to the amount of concentrated alkali metal hydroxide solution is low. More accurate metering of additive relative to alkali metal hydroxide solution may be achieved by using a solution of the additive. The concentration of additive dissolved in a solution should sufficient so that the effective concentration of alkali metal hydroxide in the freeze-protected solution is substantially unchanged. An effective concentration of additive is about 25% w/w (weight %) in water or alkali metal hydroxide solution. Other concentrations can be used so long as the amount of additive is effective to provide a freeze-protected alkali metal hydroxide solution and the concentration of alkali metal hydroxide remains above about 46% by weight, based on total weight of the solution.

The concentration of additive in the freeze-protected caustic solution, either from salt, triglyceride, or reaction of sulfuric acid or citric acid, is typically less than 1.5% by weight, based on the total weight of the solution, preferably less than 1% by weight and more preferably in the range of 0.01% (100 ppmw) to 1% (10,000 ppmw), more preferably 0.029% (290 ppmw) to 0.5% (5000 ppmw). Surprisingly, a freeze-protected alkali metal hydroxide solution is provided by having low concentrations of the chosen additive, while prior art teaches much higher concentrations of salts or other additives are necessary to achieve similar or even less effective reduction in freeze point of sodium hydroxide solutions, or alternatively lower concentration of sodium hydroxide is necessary.

In an alternative embodiment, a freeze-protected caustic solution is provided which comprises at least 46% by weight, based on total weight of the solution, of an alkali metal hydroxide, and less than 1.0%, preferably 0.01 to 0.5% by weight (100 to 5000 ppmw), more preferably 100 to 1000 ppmw, and most preferably 100 to 500 ppmw of an alkali metal salt of gluconic acid, wherein at least 80% of the total weight of alkali metal hydroxide is sodium hydroxide.

A freeze-protected solution may be prepared by a process comprising adding gluconic acid or its alkali metal salt in an appropriate amount to provide the desired concentration of alkali metal salt of gluconic acid in the freeze-protected solution, to a concentrated alkali metal hydroxide solution. The alkali metal is sodium or potassium or a mixture thereof. The alkali metal hydroxide solution comprises at least 46% by weight of alkali metal hydroxide, preferably 50 to 55% by weight. At least 80% of the total weight of alkali metal hydroxide is sodium hydroxide, preferably at least 95%, more preferably at least 99% and most preferably 100% of the total weight of alkali metal hydroxide is sodium hydroxide.

The additive, sulfuric acid or its alkali metal salt, citric acid or its alkali metal salt, triglyceride, or gluconic acid or its alkali metal salt can be added to the alkali metal hydroxide solution as desired. For example, addition can be made prior to loading a concentrated alkali metal hydroxide solution into a transportation carrier, such as a truck or trailer or rail car, or into barrels, or into drums. Addition of the additive or gluconic acid or its alkali metal salt can be made to the concentrated alkali metal hydroxide solution at anytime prior to exposure to temperatures below the freeze point of the concentrated alkali metal hydroxide solution, to provide a freeze-protected caustic solution.

The product of the process of this invention, that is, the freeze-protected caustic solution will have sustained freeze protection between temperatures at −4° C. and 5° C. (24° F. to 41° F.). For solutions comprising mixtures of sodium hydroxide and potassium hydroxide, the freeze points may be lower.

### INDUSTRIAL APPLICATION

The present invention further provides a process for using the freeze-protected caustic solution of this invention. Numerous uses are contemplated, such as for pH control, thermal energy storage, phase transfer agent, acid neutralization, or as a cleaner or a component of a cleaning solution. In one application, there is provided a process for scrubbing acid gases from gas streams comprising acid gases. This process comprises contacting the gas stream with a freeze-protected alkali metal hydroxide solution, comprising an alkali metal hydroxide and an additive, wherein the alkali metal hydroxide concentration in the solution is at least 46% by weight, based on total weight of the solution, and at least 80% by weight of the alkali metal hydroxide is sodium hydroxide; and the additive is selected from the group consisting of sulfuric acid and its alkali metal salts, citric acid and its alkali metal salts, and triglyceride, and the additive concentration is no more than 1.5% by weight, based on total weight of the solution.

### EXAMPLES

All samples were placed into 8-ounce (236 mL) glass sample bottles prior to cooling. Stock solutions of caustic (50% w/w sodium hydroxide in water), potash (45% w/w potassium hydroxide in water), sodium sulfate, sulfuric acid, and citric acid are commercially available from VWR, West Chester, Pa. Gluconic acid, 50% solution, is commercially available from PMP Fermentation Products, Inc., Peoria, Ill. Soybean oil is commercially available from Aldrich, St. Louis, Mo. A solution of 25% w/w sulfuric acid was prepared in the laboratory from concentrated sulfuric acid (100.1%), by mixing 5 g sulfuric acid in 15 g distilled water. A solution of 25% w/w sodium sulfate was prepared by mixing 5 g sodium sulfate (99.5% pure) in 15 g distilled water.

### Examples 1-13

For Examples 1-13, sulfuric acid or sodium sulfate solution was added to the caustic or caustic and potash solutions to prepare the Samples. By “caustic” in these Examples, it is meant a nominal 50% w/w solution of sodium hydroxide in water. By “potash” in these Examples, it is meant a nominal 45% w/w solution of potassium hydroxide in water. Samples were placed in a freezer where the temperature ranged from 0° C. to −4° C. (32° F. to 24° F.). Each Sample was visually checked twice each day. The temperature for each Sample was recorded twice each day for 28 days. Temperature was also recorded whether the Sample had frozen.

For the solutions, w/w means weight percent, based on total weight of the solution; ppmw means parts per million on a weight basis, based on the total weight of the solution.

### Comparative Example

A series of alkali metal hydroxide solutions were prepared and their freeze points determined. Each sample was 200 g of a 50% w/w alkali metal hydroxide aqueous solution, having the following alkali metal hydroxide compositions (weight percents, based on total alkali metal hydroxide):

Sample A 100% sodium hydroxide

Sample B 95% sodium hydroxide/5% potassium hydroxide

Sample C 80% sodium hydroxide/20% potassium hydroxide

Each sample was placed in a chiller bath filled with ethylene glycol. Sample A froze at a temperature of about 11-12° C. (52-54° F.). Sample B froze at a temperature of 1° C. (34° F.). Sample C remained liquid (unfrozen) at temperature of 0° C. (32° F.).

### Example 1

Sulfuric acid (0.8 g, 25% w/w) was added to caustic (200 g) making a sodium sulfate salt (1400 ppmw)/sodium hydroxide solution. The Sample was placed into a freezer where the temperature ranged from 0° C. to −4° C. (32° F. to 24° F.). The Sample was not frozen after 4 days of temperatures between −2° C. to −1° C. (30° F.-28° F.). The Sample froze at a temperature of −3° C. (26° F.) or colder.

### Example 2

Sodium sulfate (0.8 g, 25% w/w) was added to caustic (200 g) making a sodium sulfate salt (1000 ppmw)/sodium hydroxide solution. The Sample was placed into a freezer where the temperature ranged from 0° C. to −4° C. (32° F. to 24° F.). The Sample was not frozen after 4 days of temperatures between −2° C. to −1° C. (30° F.-28° F.). The Sample froze at a temperature of −3° C. (26° F.) or colder.

### Example 3

Sulfuric acid (0.16 g, 25% w/w) was added to caustic (200 g) making a sodium sulfate salt (290 ppmw)/sodium hydroxide solution. The Sample was placed into a freezer where the temperature ranged from 0° C. to −4° C. (32° F. to 24° F.). The Sample was not frozen after 4 days of temperatures between −2° C. to −1° C. (30° F.-28° F.). The Sample froze at a temperature of −3° C. (26° F.) or colder.

### Example 4

Sulfuric acid (1.6 g, 25% w/w) was added to caustic (200 g) making a sodium sulfate salt (2900 ppmw)/sodium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Example 5

Sodium sulfate (1.6 g, 25% w/w) was added to caustic (200 g) making a sodium sulfate salt (2000 ppmw)/sodium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Example 6

Sulfuric acid (0.8 g, 25% w/w) was added to 95:5 caustic/potash mix (200 g) making a sodium sulfate salt (1400 ppmw)/sodium hydroxide/potassium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Example 7

Sulfuric acid (1.6 g, 25% w/w) was added to 95:5 caustic/potash mix (200 g) making a sodium sulfate salt (2900 ppmw)/sodium hydroxide/potassium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Example 8

Sodium sulfate (0.8 g, 25% w/w) was added to 95:5 caustic/potash mix (200 g) making a sodium sulfate salt (1000 ppmw)/sodium hydroxide/potassium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Example 9

Sodium sulfate (1.6 g, 25% w/w) was added to 95:5 caustic/potash mix (200 g) making a sodium sulfate salt (2000 ppmw)/sodium hydroxide/potassium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Example 10

Sulfuric acid (0.8 g, 25% w/w) was added to 80:20 caustic/potash mix (200 g) making a sodium sulfate salt (1400 ppmw)/sodium hydroxide/potassium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Example 11

Sulfuric acid (1.6 g, 25% w/w) was added to 80:20 caustic/potash mix (200 g) making a sodium sulfate salt (2900 ppmw)/sodium hydroxide/potassium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Example 12

Sodium sulfate (0.8 g, 25% w/w) was added to 80:20 caustic/potash mix (200 g) making a sodium sulfate salt (1000 ppmw)/sodium hydroxide/potassium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Example 13

Sodium sulfate (1.6 g, 25% w/w) was added to 80:20 caustic/potash mix (200 g) making a sodium sulfate salt (2000 ppmw)/sodium hydroxide/potassium hydroxide solution. The Sample was placed into a freezer where the temperature ranged from 0° C. to −4° C. (32° F. to 24° F.). The Sample was not frozen after 28 days, even after temperature was lowered to −4° C. (24° F.).

### Examples 14-33

For Examples 14-33, an additive, sulfuric acid, sodium sulfate, gluconic acid or citric acid was added to the caustic or caustic/potash solutions to prepare the Samples. Samples were prepared by adding the additive to the aqueous caustic or aqueous caustic/potash solution in 8-ounce (236 mL) glass bottles and stirring as needed to dissolve the additive. Each Sample was placed in a freezer with temperature control from 10° C. (50° F.) to −1° C. (30° F.). Samples were checked at least once each day and often twice each day for temperature and to determine whether the Sample was frozen.

Samples were placed into a temperature controlled, chilled circulating ethylene glycol bath where the temperature ranged from 10° C. to 0° C. (50° F. to 32° F.). Each Sample was visually checked twice each day. The temperature for each Sample was recorded twice each day for up to 9 days. Temperature was also recorded whether the Sample had frozen.

### Example 14

Sulfuric acid (0.055 g, 25% w/w) was added to caustic (200 g) making a sodium sulfate salt (100 ppmw)/sodium hydroxide solution. The Sample was placed into a chilled circulating ethylene glycol bath where the temperature ranged from 10° C. to 2° C. (50° F. to 35.6° F.). The Sample froze when the temperature reached 5° C. (41° F.).

This Sample was unfrozen by warming to room temperature and stirring. Then, 100 ppm of gluconic acid, from a 50% w/w aqueous solution was added. The Sample was placed into a chilled circulating ethylene glycol bath where the temperature ranged from 3° C. to 0° C. (37° F. to 32° F.) over 3 days. The Sample froze when the temperature reached 0° C. (32° F.) on the third day.

### Example 15

Sulfuric acid (0.110 g, 25% w/w) was added to caustic (200 g) making a sodium sulfate salt (200 ppmw)/sodium hydroxide solution. The Sample was placed into a chilled circulating ethylene glycol bath where the temperature ranged from 10° C. to 2° C. (50° F. to 35.6° F.). The Sample froze when the temperature reached 5° C. (41° F.).

This Sample was unfrozen by warming to room temperature and stirring. Then, 100 ppm of gluconic acid, from a 50% w/w aqueous solution was added. The Sample was placed into a chilled circulating ethylene glycol bath where the temperature ranged from 3° C. to 0° C. (37° F. to 32° F.) over 3 days. The Sample froze when the temperature reached 0° C. (32° F.) on the third day.

### Example 16

Sulfuric acid (0.275 g, 25% w/w) was added to caustic (200 g) making a sodium sulfate salt (500 ppmw)/sodium hydroxide solution. The Sample was placed into a chilled circulating ethylene glycol bath where the temperature ranged from 10° C. to 2° C. (50° F. to 35.6° F.). The Sample froze when the temperature reached 5° C. (41° F.).

This Sample was unfrozen by warming to room temperature and stirring. Then, 100 ppm of gluconic acid, from a 50% w/w aqueous solution was added. The Sample was placed into a chilled circulating ethylene glycol bath where the temperature ranged from 3° C. to 0° C. (37° F. to 32° F.) over 3 days. The Sample froze when the temperature reached 0° C. (32° F.) on the third day.

### Example 17

Sulfuric acid (0.555 g, 25% w/w) was added to caustic (200 g) making a sodium sulfate salt (1000 ppmw)/sodium hydroxide solution. The Sample was placed into a chilled circulating ethylene glycol bath where the temperature ranged from 10° C. to 2° C. (50° F. to 35.6° F.). The Sample froze when the temperature reached 4° C. (39° F.).

The frozen Sample was warmed to form a liquid and then additional sulfuric acid (25% w/w) was added to increase concentration of sodium sulfate to 0.5% w/w (5000 ppmw). The Sample was placed into a chilled circulating ethylene glycol bath where the temperature ranged from 3° C. to 0° C. (37° F. to 32° F.). After 3 days, at a final temperature of 0° C. (32° F.), the sample remained liquid, with some solid precipitate of sodium sulfate having formed in the bottom of the Sample, suggesting this Sample was saturated with sodium sulfate at the temperature of 0° C. (32° F.).

This Sample remained in the chilled circulating ethylene glycol bath where the temperature ranged from 3° C. to −1° C. (37° F. to 30° F.). After 4 additional days, with temperature reduced to −1° C. (30° F.) on the last day, the Sample remained unfrozen.

### Example 18

Sulfuric acid (1.11 g, 25% w/w) was added to caustic (200 g) making a sodium sulfate salt (2000 ppmw)/sodium hydroxide solution. The Sample was placed into a chilled circulating ethylene glycol bath where the temperature ranged from 10° C. to 2° C. (50° F. to 35.6° F.). The Sample froze when the temperature reached 4° C. (39° F.).

The frozen Sample was warmed to form a liquid and then additional sulfuric acid (25% w/w) was added to increase concentration of sodium sulfate to 1.0% w/w (10,000 ppmw). The Sample was placed into a chilled circulating ethylene glycol bath where the temperature ranged from 3° C. to 0° C. (37° F. to 32° F.). After 3 days, at a final temperature of 0° C. (32° F.), the sample remained liquid, with some solid precipitate of sodium sulfate having formed in the bottom of the Sample, suggesting this Sample was saturated with sodium sulfate at the temperature of 0° C. (32° F.).

This Sample remained in the chilled circulating ethylene glycol bath where the temperature ranged from 3° C. to −1° C. (37° F. to 30° F.). After 4 additional days, with temperature reduced to −1° C. (30° F.) on the last day, the Sample remained unfrozen.

### Example 19

Sodium sulfate (0.08 g, 25% w/w) was added to caustic (200 g) making a sodium sulfate salt (100 ppmw)/sodium hydroxide solution. The Sample was placed into a chilled circulating ethylene glycol bath where the temperature ranged from 10° C. to 2° C. (50° F. to 35.6° F.). The Sample froze when the temperature reached 5° C. (41° F.).

This Sample was unfrozen by warming to room temperature and stirring. Then, 100 ppm of gluconic acid, from a 50% w/w aqueous solution was added. The Sample was placed into a chilled circulating ethylene glycol bath where the temperature ranged from 3° C. to 0° C. (37° F. to 32° F.) over 3 days. The Sample froze when the temperature reached 0° C. (32° F.) on the third day.

### Example 20

Sodium sulfate (0.16 g, 25% w/w) was added to caustic (200 g) making a sodium sulfate salt (200 ppmw)/sodium hydroxide solution. The Sample was placed into a chilled circulating ethylene glycol bath where the temperature ranged from 10° C. to 2° C. (50° F. to 35.6° F.). The Sample froze when the temperature reached 5° C. (41° F.).

This Sample was unfrozen by warming to room temperature and stirring. Then, 100 ppm of gluconic acid, from a 50% w/w aqueous solution was added. The Sample was placed into a chilled circulating ethylene glycol bath where the temperature ranged from 3° C. to 0° C. (37° F. to 32° F.) over 3 days. The Sample froze when the temperature reached 0° C. (32° F.) on the third day.

### Example 21

Sodium sulfate (0.4 g, 25% w/w) was added to caustic (200 g) making a sodium sulfate salt (500 ppmw)/sodium hydroxide solution. The Sample was placed into a chilled circulating ethylene glycol bath where the temperature ranged from 10° C. to 2° C. (50° F. to 35.6° F.). The Sample froze when the temperature reached 4° C. (39° F.).

This Sample was unfrozen by warming to room temperature and stirring. Then, 100 ppm of gluconic acid, from a 50% w/w aqueous solution was added. The Sample was placed into a chilled circulating ethylene glycol bath where the temperature ranged from 3° C. to 0° C. (37° F. to 32° F.). The Sample froze when the temperature reached 0° C. (32° F.).

### Example 22

Sodium sulfate (0.8 g, 25% w/w) was added to caustic (200 g) making a sodium sulfate salt (1000 ppmw)/sodium hydroxide solution. The Sample was placed into a chilled circulating ethylene glycol bath where the temperature ranged from 10° C. to 2° C. (50° F. to 35.6° F.). The Sample froze when the temperature reached 4° C. (39° F.).

The frozen Sample was warmed to form a liquid and then additional sodium sulfate (25% w/w) was added to increase concentration of sodium sulfate to 0.5% w/w (5000 ppmw). The Sample was placed into a chilled circulating ethylene glycol bath where the temperature ranged from 3° C. to 0° C. (37° F. to 32° F.). After 3 days, at a final temperature of 0° C. (32° F.), the sample remained liquid, with some solid precipitate of sodium sulfate having formed in the bottom of the Sample, suggesting this Sample was saturated with sodium sulfate at the temperature of 0° C. (32° F.).

This Sample remained in the chilled circulating ethylene glycol bath where the temperature ranged from 3° C. to −1° C. (37° F. to 30° F.). After 4 additional days, with temperature reduced to −1° C. (30° F.) on the last day, the Sample remained unfrozen.

### Example 23

Sodium sulfate (1.61 g, 25% w/w) was added to caustic (200 g) making a sodium sulfate salt (2000 ppmw)/sodium hydroxide solution. Sample was placed into a chilled circulating ethylene glycol bath where the temperature ranged from 10° C. to 2° C. (50° F. to 35.6° F.). The sample froze when the temperature reached 4° C. (39° F.).

The frozen Sample was warmed to form a liquid and then additional sodium sulfate (25% w/w) was added to increase concentration of sodium sulfate to 1.0% w/w (10,000 ppmw). The Sample was placed into a chilled circulating ethylene glycol bath where the temperature ranged from 3° C. to 0° C. (37° F. to 32° F.). After 3 days, at a final temperature of 0° C. (32° F.), the sample remained liquid, with some solid precipitate of sodium sulfate having formed in the bottom of the Sample, suggesting this Sample was saturated with sodium sulfate at the temperature of 0° C. (32° F.).

This Sample remained in the chilled circulating ethylene glycol bath where the temperature ranged from 3° C. to −1° C. (37° F. to 30° F.). After 4 additional days, with temperature reduced to −1° C. (30° F.) on the last day, the Sample remained unfrozen.

### Example 24

Sulfuric acid (0.055 g, 25% w/w) was added to 95:5 caustic/potash mix (200 g) making a sodium sulfate salt (100 ppmw)/sodium hydroxide/potassium hydroxide solution. The Sample was placed into a chilled circulating ethylene glycol bath where the temperature ranged from 10° C. to 2° C. (50° F. to 35.6° F.). The Sample was not frozen after 9 days.

### Example 25

Sulfuric acid (0.11 g, 25% w/w) was added to caustic (200 g) making a sodium sulfate salt (200 ppmw)/sodium hydroxide solution. The Sample was placed into a chilled circulating ethylene glycol bath where the temperature ranged from 10° C. to 2° C. (50° F. to 35.6° F.). The Sample was not frozen after 9 days.

### Example 26

Sodium sulfate (0.08 g, 25% w/w) was added to 95:5 caustic/potash mix (200 g) making a sodium sulfate salt (100 ppmw)/sodium hydroxide/potassium hydroxide solution. The Sample was placed into a chilled circulating ethylene glycol bath where the temperature ranged from 10° C. to 2° C. (50° F. to 35.6° F.). The Sample was not frozen after 9 days.

### Example 27

Sodium sulfate (0.16 g, 25% w/w) was added to 95:5 caustic/potash mix (200 g) making a sodium sulfate salt (200 ppmw)/sodium hydroxide/potassium hydroxide solution. The Sample was placed into a chilled circulating ethylene glycol bath where the temperature ranged from 10° C. to 2° C. (50° F. to 35.6° F.). The Sample was not frozen after 9 days.

### Example 28

Sulfuric acid (2.8 g, 25% w/w) was added to caustic (200 g) making a sodium sulfate salt (5,000 ppmw)/sodium hydroxide solution. The Sample was placed into a chilled circulating ethylene glycol bath where the temperature ranged from 3° C. to 0° C. (37.4° F. to 32° F.). The Sample was not frozen after 3 days.

### Example 29

Sulfuric acid (5.678 g, 25% w/w) was added to caustic (200 g) making a sodium sulfate salt (10,000 ppmw)/sodium hydroxide solution. The Sample was placed into a chilled circulating ethylene glycol bath where the temperature ranged from 3° C. to 0° C. (37.4° F. to 32° F.). The Sample was not frozen after 3 days.

### Example 30

Sodium sulfate (4.078 g, 25% w/w) was added to caustic (200 g) making a sodium sulfate salt (5,000 ppmw)/sodium hydroxide solution. The Sample was placed into a chilled circulating ethylene glycol bath where the temperature ranged from 3° C. to 0° C. (37.4° F. to 32° F.). The Sample was not frozen after 3 days.

### Example 31

Sodium sulfate (8.33 g, 25% w/w) was added to caustic (200 g) making a sodium sulfate salt (10,000 ppmw)/sodium hydroxide solution. The Sample was placed into a chilled circulating ethylene glycol bath where the temperature ranged from 3° C. to 0° C. (37.4° F. to 32° F.). The Sample was not frozen after 3 days.

### Example 32

Gluconic acid (2 g, 50% w/w) was added to caustic (198 g) making a sodium salt of gluconic acid (130 ppmw)/sodium hydroxide solution. The Sample was placed into a chilled circulating ethylene glycol bath where the temperature ranged from 3° C. to 0° C. (37° F. to 32° F.). After 3 days, at a final temperature of 1° C. (34° F.), the sample remained liquid. When the temperature of the bath was lowered to 0° C. (32° F.), this Sample froze.

### Example 33

Citric acid (2 g, 50% w/w) was added to caustic (198 g) making a sodium salt of citric acid (200 ppmw)/sodium hydroxide solution. The sample was placed into a chilled circulating ethylene glycol bath where the temperature ranged from 3° C. to 0° C. (37° F. to 32° F.). After 2 days, at a final temperature of 1° C. (34° F.), the sample remained liquid. When the temperature of the bath was lowered to 0° C. (32° F.), this Sample froze.

### Example 34

Sufficient soybean oil was added to caustic (200 g) to make a solution containing 50% sodium hydroxide/500 ppmw soybean oil solution. The sample was placed into a chilled circulating ethylene glycol bath where the temperature ranged from 3° C. to 0° C. (37° F. to 32° F.). After 24 hours at a temperature of 2° C. (36° F.), the sample remained liquid. The temperature was lowered to 1° C. (34° F.), and after 24 hours, the sample still remained liquid. The temperature was lowered to 0° C. (32° F.), and after 6 hours, the sample still remained liquid. After 3 days at 0° C. (32° F.), this sample froze.

What is claimed is:

1. A freeze-protected caustic solution comprising (a) at least 46% by weight, based on total weight of the solution, of an alkali metal hydroxide, and (b) no more than 1.5% by weight of an additive selected from the group consisting of sulfuric acid and its alkali metal salts, citric acid and its alkali metal salts, and triglyceride, wherein the alkali metal is sodium, potassium or mixtures thereof and at least 80% of the total weight of the alkali metal hydroxide is sodium hydroxide and wherein the solution has a freeze point of 5° C. or less.

2. The solution of claim 1 wherein the solution comprises 48 to about 50% by weight of the alkali metal hydroxide.

3. The solution of claim 1 wherein the solution comprises 50 to about 55% by weight of the alkali metal hydroxide, and wherein 95% to 100% of the total weight of the alkali metal hydroxide is sodium hydroxide.

4. The solution of claim 3 wherein 100% of the alkali metal hydroxide is sodium hydroxide.

5. The solution of claim 3 wherein the solution comprises 0.01 to 1% by weight of the additive, based on the total weight of the solution.

6. The solution of claim 6 wherein the solution comprises 0.029% to 0.5% by weight of the additive, based on the total weight of the solution.

7. The solution of claim 3 wherein the additive is sulfuric acid or sodium sulfate.

8. The solution of claim 3 wherein the additive is triglyceride.

9. The solution of claim 8 wherein the triglyceride is a vegetable oil selected from the group consisting of canola oil and soybean oil.

10. The solution of claim 1 wherein the solution has a freeze point of −4° C. to 5° C.

11. A freeze-protected caustic solution comprising (a) at least 46% by weight, based on total weight of the solution, of an alkali metal hydroxide, and (b) less than 1.0% by weight, of alkali metal salt of gluconic acid, wherein at least 80% of the total weight of alkali metal hydroxide is sodium hydroxide, and the solution has a freeze point of 5° C. or less.

12. The solution of claim 11 comprising 0.01 to 0.5% by weight (100 to 5000 parts per million by weight, ppmw) of alkali metal salt of gluconic acid, based on the total weight of the solution.

13. The solution of claim 12 comprising 0.01 to 0.1% by weight of alkali metal salt of gluconic acid, based on the total weight of the solution.

14. The solution of claim 11 wherein the solution comprises 48 to about 50% by weight of the alkali metal hydroxide.

15. The solution of claim 11 wherein the solution comprises 50 to about 55% by weight of the alkali metal hydroxide, and wherein 95% to 100% of the total weight of the alkali metal hydroxide is sodium hydroxide.

16. The solution of claim 15 wherein 100% of the alkali metal hydroxide is sodium hydroxide.

17. A process to prepare a freeze-protected alkali metal hydroxide solution comprising adding sulfuric acid or alkali metal sulfate to an alkali metal hydroxide solution wherein the alkali metal hydroxide solution comprises at least 46% by weight, based on total weight of the solution, of an alkali metal hydroxide, at least 80% of the total weight of the alkali metal hydroxide is sodium hydroxide, and wherein the solution has a freeze point of 5° C. or less.

18. The process of claim 17, further comprising pre-dissolving the alkali metal sulfate in water or aqueous alkali metal hydroxide prior to adding to the alkali metal hydroxide solution.

19. The process of claim 17, where the alkali metal sulfate is made in situ by adding sulfuric acid to the alkali metal hydroxide solution.

20. A process for scrubbing acid gases from gas streams comprising acid gases, which process comprises contacting the gas stream with a freeze-protected alkali metal hydroxide solution, wherein the solution comprises an alkali metal hydroxide and an additive, wherein the alkali metal hydroxide concentration in the solution is at least 46% by weight, based on total weight of the solution, at least 80% by weight of the alkali metal hydroxide is sodium hydroxide; the additive is selected from the group consisting of sulfuric acid and its alkali metal salts, citric acid and its alkali metal salts, and triglyceride, the additive concentration is no more than 1.5% by weight, based on total weight of the solution, and the solution has a freeze point of 5° C. or less.
